(19) United States
(12) Patent Application Publication
(10) Pub. No.: US 2010/0036662 A1
(43) Pub. Date: Feb. 11, 2010

(54) JOURNALING DEVICE AND INFORMATION MANAGEMENT SYSTEM

(76) Inventor: David J. Emmons, Plymouth, MN (US)

Correspondence Address: MERCHANT & GOULD PC, P.O. BOX 2903, MINNEAPOLIS, MN, 55402-0903, US

(21) Appl. No.: 12/537,004

(22) Filed: Aug. 6, 2009

Related U.S. Application Data
(60) Provisional application No. 61/086,709, filed on Aug. 6, 2008.

(51) Int. Cl. G10L 15/26

(52) U.S. Cl. 704/235; 704/E15.043

(57) ABSTRACT

A portable journaling device is useful for thought and behavior tracking, documenting, optimizing, teaching, and training. The device is arranged and configured to receive and store voice data, and to transmit the received voice data to a server. The server transcribes the voice data, if possible, and stores the transcribed data. If the server is unable to transcribe the voice data, the voice data is automatically forwarded to a data transcription service for manual transcription. The manually transcribed data is then received by the server where the manually transcribed data is stored.

### CROSS REFERENCE TO RELATED APPLICATION

This application claims priority to U.S. Provisional Application Ser. No. 61/086,709 filed on Aug. 6, 2008, entitled JOURNALING DEVICE AND INFORMATION MANAGEMENT SYSTEM, the disclosure of which is hereby incorporated by reference in its entirety.

### TECHNICAL FIELD

The present disclosure relates generally to systems and methods that facilitate efficient data logging and information management. More specifically, the present disclosure relates to a journaling device and information management system.

### BACKGROUND

Journaling is sometimes used in various situations to record information. For example, a doctor or lawyer will typically chronicle a given day by recording notable event information such as the amount of time spent on a given matter and a narrative of what was done during that time.

One issue with journaling stems from the tedious nature of recording information. Typically, journaling is a multi-step process that is time consuming and therefore not conducive to modem lifestyles. Further, some attempts to alleviate issues associated with journaling have exacerbated the problem by introducing complex technologies that require substantial front end time investment to navigate the learning curve as well as additional steps to record the events.

### SUMMARY

In general terms, the present disclosure relates to a journaling device, and more particularly to a journaling device capable of communicating with an information management system.

One aspect is a portable journaling device comprises an input device configured to receive input from a user, an output device configured to generate output to the user, a communication device configured to send and receive digital data, a processing unit, and one or more memory elements. The one or more memory elements store instructions executable by the processing unit, wherein the instructions, when executed by the processing unit, cause the processing unit to perform a method comprising: receiving a voice input from a user upon activation of the input device; storing the voice input as voice data in the at least one memory element; sending the voice data with the communication device to a remote server device; receiving non-voice data from the remote server through the computer, the non-voice data relating to the voice data; and generating an output to the user with the output device, the output relating to the non-voice data received from the remote server.

Another aspect is an information management system, comprising: a portable journaling device configured to acquire, transfer, and present information, the journaling device comprising a processing unit, a memory device coupled to the processor and having at least one software application comprising instructions executable by the processing unit stored thereon, and an accelerometer coupled to the processor and configured to acquire information corresponding to an amount of activity of a user; a server configured for at least receiving and storing information as acquired by the portable journaling device, the server comprising an information database and a voice recognition module, wherein the voice recognition module transcribes information as received from the portable journaling device; and a data entry service configured to transcribe information as received from the server upon unsuccessful transcription by the voice recognition module and return the transcribed information to the server.

Yet another aspect is a method for operating a health information management system, the method comprising: receiving, at a server device via a communication network, voice data comprising weight management and health data from a portable journaling device; attempting to convert the received voice data into a text format at the server device; if attempting to convert is unsuccessful, automatically sending the voice data from the server device to a transcription service for manual transcription, and upon successful transcription of the received voice data, storing the transcribed data in an information database at the server.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### DESCRIPTION OF THE DRAWINGS

Aspects of the present disclosure may be more completely understood in consideration of the following detailed description of various embodiments in connection with the accompanying drawings, in which:

FIG. 1 is a block diagram of an example information management system;

FIG. 2 is a diagram of hardware resources of a portable journaling device

FIG. 3 is a perspective view of an example portable journaling device;

FIG. 4 is an first example of a user interface display for the portable journaling device of FIG. 3;

FIG. 5 is a second example of a user interface display for the portable journaling device of FIG. 3;

FIG. 6 is a third example of a user interface display for the portable journaling device of FIG. 3;

FIG. 7 is a method of operation of information management system concerning data as acquired by the portable journaling device of FIG. 3; and

FIG. 8 is a diagram of software resources of a server as depicted in the information management system of FIG. 1.

### DETAILED DESCRIPTION

This disclosure will now more fully describe exemplary embodiments with reference to the accompanying drawings, in which specific embodiments are shown. Other aspects may, however, be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

Journaling is useful for engineers and scientists as a way to record their thoughts and ideas, where, for example, these records can be used to document invention time and date.

Journaling is also useful in identifying behaviours that impact an individual's health, such as food consumption and exercise routines. In this manner, chronicled information can be analyzed and reflected on such that informed decisions are made.

Journaling is also useful in budgeting and financial management. Some people use check book registers to track their spending and account balances. Business travelers track their business expenses by saving receipts and then recalling and journaling their business trips for tax purposes. In addition, the process of journaling can help a consumer change their behaviour by making their current behaviour more conscience to them and giving them feedback on their current choices. It is believed that to change human behaviour you first need to have an accurate measure of the variable/behaviour. You then need to exalt/reward/give positive feedback to the individual for movement toward the desired outcome and rebuke/hold accountable/support/encourage/console the consumer for movement away from the desired outcome.

Journaling is also useful for keeping track of conversations and correspondence with customers. For example, sales peoples can track sales activities that may in turn be analyzed, optimized to help a companies maximize its overall sales force effectiveness. Corporate executives, policy makers, research scientists and engineers, political leaders and other thought leaders need to think about and process extremely complex problems. In addition many of these people are being asked to manage many different and competing projects and priorities.

Solving difficult intellectual problems requires extreme focus and requires the person to first reach a critical mass of thought before they can the achieve the breakthrough idea. Constant shifting of priorities in the fast paced world means that as a person is building toward this “critical thought mass” on a particular problem they are distracted long enough by other day to day activities that they lose their train of thought. When they come back to the problem they need to start over and waste time recounting their thought process and may ultimately never reach the breakthrough idea. Simplified journaling in this case is a way to easily capture the detail of a thought and then be able to quickly and easily recall it later when time permits to add to and build toward the critical mass of thought and ultimately the breakthrough idea.

Many people who use checks do not accurately use their check book registers and do not understand where they spend their money. Most people that are overweight have very little idea what they eat on a daily basis. In the fast paced modern world people simply do not have the time or the inclination to accurately track and measure their finances, food, and daily behaviours. A solution that requires consumers to make minimal change to their daily habits or require only a minimal amount of effort are more likely to be tried by the consumer and eventually adopted. Journaling is a powerful technique for behaviour modification and the simplified journaling disclosed herein will likely increase consumer trial and adoption rates. Sustained behaviour modification through simplified journaling will lead to new positive habits that will yield desired outcomes.

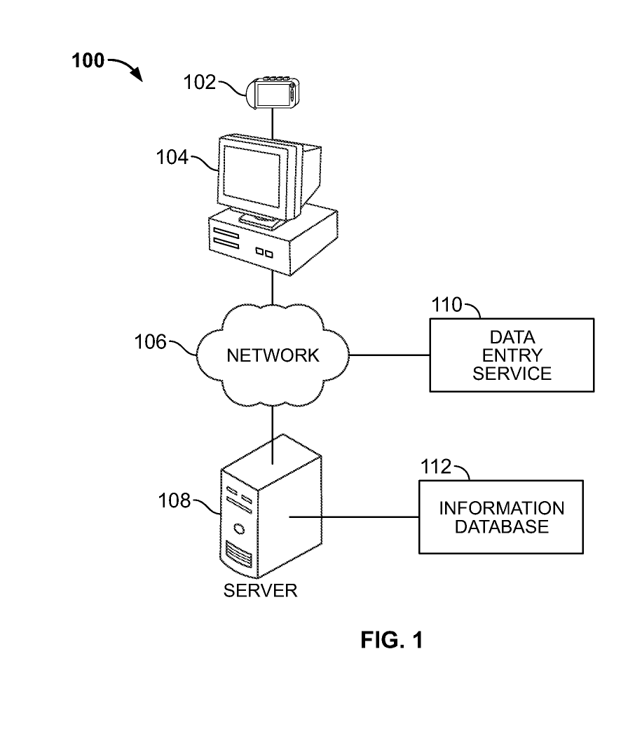

FIG. 1 is an example embodiment of an information management system 100 according to the principles of the present disclosure. System 100 includes a portable journaling device 102, a computing system 104, a communication network 106, a server 108, and a data entry service 110. Server 108 includes information database 112.

In one embodiment, data is entered into journaling device 102 along with a corresponding time stamp. Data is organized into a predetermined format and transferred to computing system 104. Computing system 104 is configured to receive and transfer the data to server 108 via communication network 106. In some embodiments, server 108 is a computing system that includes a plurality of functional modules to organize and manipulate the data and store the data in information database 112. In some embodiments, data is transferred back to journaling device 102 via communication network 106 and computing system 104 for presentation to the user. In some embodiments, one or more portions of formatted data are received from the journaling device 102 but are uninterpretable by server 108. The received data is, in some embodiments, transferred to data entry service 110 via communication network 106 for manual review or transcription. The transcribed data is then transferred back to server 108, where it is stored in the information database 112.

In some embodiments the data is also sent to journaling device 102 via communication network 106 and computing system 104 for presentation to the user. Processed data stored in information database 112 on server 108 can additionally be remotely accessible via a secure Internet software application such as a web browser. In certain embodiments, the journaling device 102 and communication means may be enabled by a cell phone or personal digital assistant (PDA) device, where the application intelligence would be a software application that would be licensed to an original equipment manufacturer, for example.

In some embodiments, information management system 100 is a health management system that allows a user to record and manage health information. For example, information management system 100 is used in some embodiments to record and monitor information for weight management.

Accurate journaling of calorie consumption, for example, has been found to be correlated to weight loss. Weight loss and sustainable weight loss have been shown to be further enhanced by robust feedback and support. Information management system 100 is used in some embodiments to accurately record and monitor health factors and to provide relevant feedback to the user. The user may then use the information to make healthy choices that lead to weight loss or other improvements in health. Information management system 100 allows a user to maintain an accurate record of health information in a manner that is fast and easy, so as to not require drastic changes in habits or routines to record the information.

In some embodiments, the information management system 100 is arranged and configured to perform a revenue generating method. For example, the revenue generating method may comprise a monthly subscription fee, use as an advertising medium, sale or rental of a journaling device, a software maintenance fee, consultations or advice from a personal trainers, consultations or advice from a financial advisor, consultations or advice from a personal assistant, sales of a plurality of media including books, tapes, food, exercise equipment, social networking, one or more product endorsements, one or more brands licensing, and others as well.

Additionally, in some embodiments the information management system 100 is arranged and configured for the management of at least one of: a health management program, a financial management application, an expense tracking, a billable hour tracking for contract professionals, an invention history recording, personal time management, project management/communication/critical path management/team motivation, prayer journaling, and thought process management.

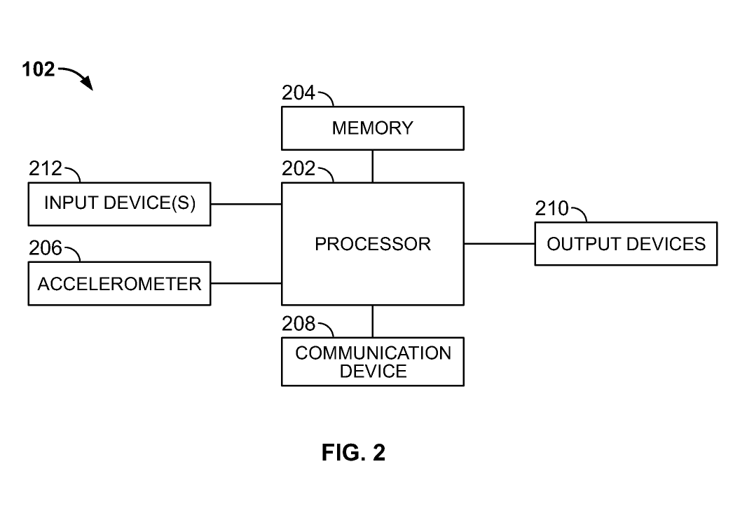

FIG. 2 is a schematic block diagram of an exemplary journaling device 102. In some embodiments, journaling device 102 is a portable, pocket sized computing device which comprises hardware and software. In one embodiment, journaling device 102 includes a processor 202, a memory element 204, an accelerometer 206, a communication device 208, input devices 212 and output devices 210. Additionally, in some embodiments journaling device 102 includes one or more software applications, such as a journaling program or an Internet browser.

In general, a processor is a processing device that processes a set of instructions. In one embodiment, processor 202 is a microprocessor. In other embodiments processor 202 is a control logic circuit such as a field programmable gate array (FPGA). Alternatively, various other processing devices may also be used including central processing units (“CPUs), microcontrollers, digital signal processing (“DSP”) devices, and the like. Processing devices may be of any general variety such as reduced instruction set computing (RISC) devices, complex instruction set computing devices (“CISC”), or specially designed processing devices such as an application-specific integrated circuit (“ASIC”) device. In some embodiments, memory element 204 is part of the processor 202, while in other embodiments memory element is separate from or in addition to that of the processor 202. In example embodiments, memory element 204 is a non-volatile memory element, a volatile memory element, or any combination thereof. Accelerometer 206 can be any device configured to measure acceleration and gravity induced reaction forces. In certain embodiments, accelerometer 206 is incorporated into memory element 204, and vice versa. In general, communication device 208 can be any device configured to support a data transfer protocol between journaling device 102 and another device or system. In example embodiments, input devices 212 include any means to input information into journaling device 102 and output device 210 include any means to output information from journaling device 102.

In some embodiments, journaling device 102 is a device that automatically acquires activity data. For example, an accelerometer 206 is provided in some embodiments to record movement of the journaling device 102 that corresponds to an amount of activity of a user. In certain embodiments, the accelerometer 206 is a MEMS device incorporated into a memory card compatible with a PDA, a smartphone, and other types of handheld computing devices. In some example embodiments, firmware and other instructions are stored on one or both of the memory card and other non-volatile memory incorporated in the memory card for the purpose of implementing one or more methods according to the principles of the present disclosure.

Journaling device 102 can also be manually activated to acquire data via a user friendly interface. In certain embodiments, the journaling device includes a password lockout or a biometric lockout.

In some embodiments, journaling device 102 processes acquired data internally and presents the processed data to a user. Additionally, in some embodiments journaling device 102 transfers the acquired data to an external location for processing and then receives the processed data back for presentation to the user. Alternatively, the information processed at the external location is accessed remotely. For example, the processed information can be accessed on a secure Internet website via a communication network 106.

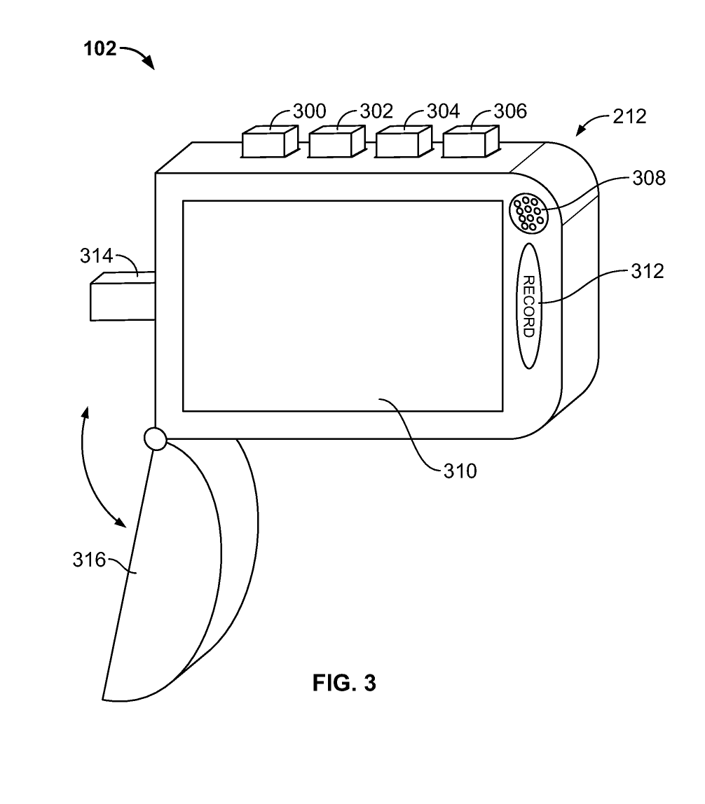

FIG. 3 is a schematic perspective view of an exemplary journaling device 102. In this example, journaling device 102 includes a plurality of input devices 212 such as buttons 300, 302, 304, 306, microphone 308, touch display 310, and voice record button 312. Other input devices can include a digital photography device (not shown), such as including a charge-coupled device. Display 310 and microphone 308 dually function as output devices 210 in some embodiments. Various types of output devices are used in different embodiments. Typically, the output device presents or displays information to a user. Examples of output devices include light emitting diodes (LED), displays, and vibrators. In the example embodiment, a universal serial bus (USB) port 314 functions as a communication device 208 for data transfer between journaling device 102 and computing system 104. In some embodiments, the journaling device 102 includes an RF transceiver, optical transceiver, Bluetooth, or other know communication device to transfer information to computing system 104, or to server 108 via communication network 106. In some embodiments, a protective cover 316 is pivotally actuated to protect the USB port 314.

Input devices 212 are utilized to enter or record weight management related information. For example, in some embodiments input devices 212 act to capture real time energy balance information wherein “calories-in” is captured via buttons 300, 302, 304, 306, microphone 308, touch display 310, voice record button 312, and/or a digital photography device. “Calories-out” is captured, for example, via accelerometer 206 or buttons 300, 302, 304, 306.

As one example, touch display 310 and buttons 300, 302, 304, 306 are used to manually enter information such as water, protein, fat, carbohydrates, sodium, and fiber intake, among others. Microphone 308 and voice record button 312 can be utilized to record voice data entries. In alternate embodiments, journaling device 102 can take input from an external device such as a bath scale that records biometric information such as weight, body mass index, pulse, and other relevant health variables. 13.

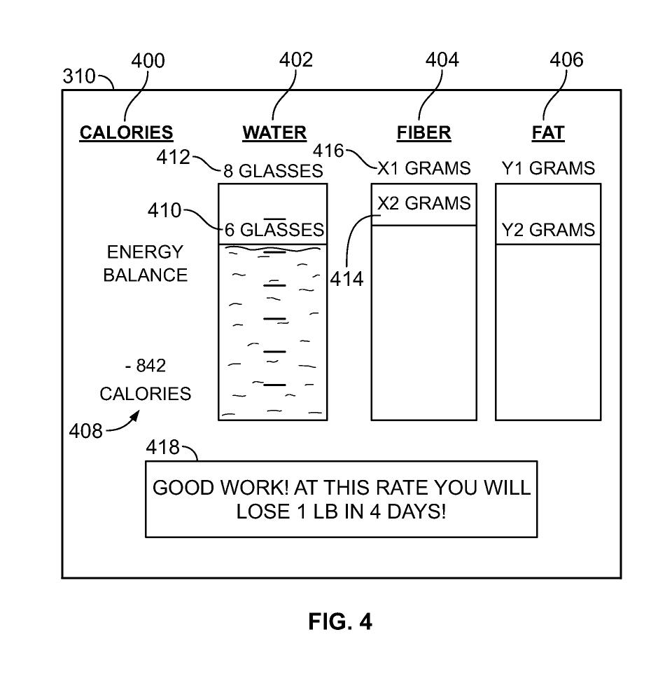

FIG. 4 is an example user interface display 310 demonstrating a real time display of weight management related data as acquired by journaling device 102. In the example shown, four columns 400, 402, 404 and 406 are illustrated representing a running balance of caloric, water, fiber, and fat intake. In one aspect, the respective weight management data is entered via input devices 212, described in further detail below.

In the example shown, calories column 400 is a display of the real time value of the energy balance equation, which compares the number of calories consumed versus the number of calories expended (calories-in versus calories out) over a predefined time period. In the example, a value of −842 calories is displayed 408, indicating a net expenditure of 842 calories. Water column 402 can display the number of glasses of water consumed by the user over the predefined time period with respect to a recommended daily intake 412. In one embodiment, the number of glasses of water can be tracked by the user by depressing a button respective, such as button 300. Fiber column 404 tracks the amount of fiber consumed. In one embodiment, the user manually enters the amount of fiber can be tracked by the user by depressing a button respective, such as button 302. In an alternative embodiment, journaling device 102 or server 108 can query a database for the type of food consumed such that the fiber content can be downloaded and accounted for. Fiber intake column 404 can display a real time fiber intake value 414 and a predefined fiber intake limit value 416 such that the user can make educated decisions. Fat column 406 can be updated to reflect fat consumption in a similar manner to the fiber column 404.

In one embodiment, real time feedback is provided based on the status of the weight management data displayed by display 310. For example, a message 418 communicates feedback such as “Good Work! At this rate you will lose 1 pound in 4 days” to the user. In alternative embodiments, a text message or an email is sent to present the user with useful or requested information. In further embodiments, diet and activity suggestions are made.

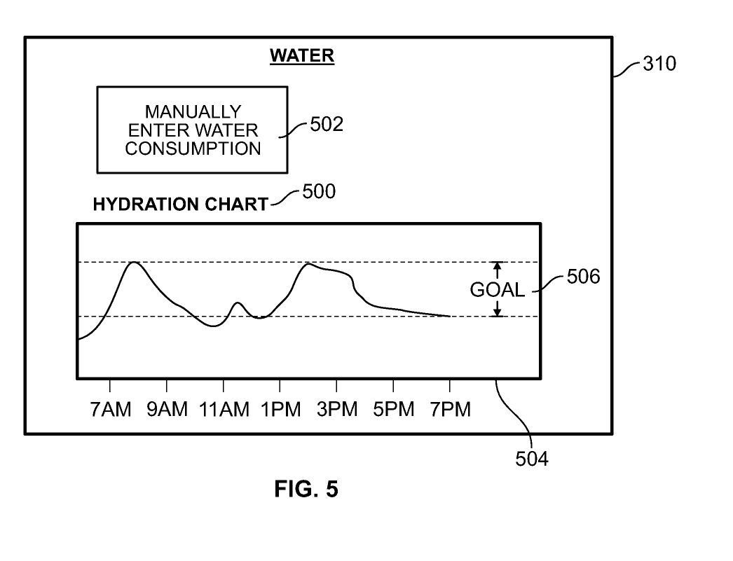

FIG. 5 is an example user interface display 310 displaying a hydration chart 500 which indicates to the user a hydration trend. In one embodiment, water consumption is manually entered data via input 502 into the journaling device 102 and real time user hydration can be calculated. For example, the state of current hydration can be determined by an algorithm that can factor in the number of glasses of water consumed and activity information as measure by accelerometer 206. The x-axis 504 of the hydration chart 500 may zoom in or zoom out to display any desired time span (e.g., a daily hydration trend chart can be displayed). Additionally, a desired hydration zone 506 can be displayed to indicate to the user that water intake should be increased or decreased.

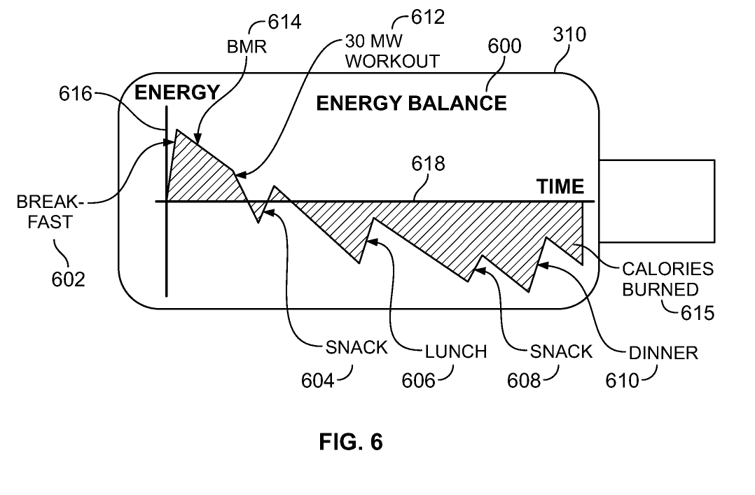

FIG. 6 is an example user interface display 310 displaying an energy balance chart 600 which indicates to the user the number of calories consumed versus the number of calories expended (calories-in versus calories out) over a predefined time period. Energy balance chart 600 can be used as a tool to understand the impact of various activities such as eating and exercise. For example, the chart 600 can be used to interpret the impact of eating breakfast 602, first snack 604, lunch 606, second snack 608, and dinner 610. Additionally, the effect of physical activity such as workout 612 and an understanding of the user's basal metabolic rate (BMR) 614 can be understood based on evaluation of the slope of chart 600 during a resting period. Further, an algorithm can be utilized to calculate the number of calories burned, 615, during a given time period by evaluating the area under chart 600 during energy expenditure (negative energy balance equation).

In one example embodiment, “calories-in” can be captured via a combination of buttons 300, 302, 304, 306, microphone 308, touch display 310, voice record button 312, and digital photography devices. Additionally, “calories-out” can be captured via accelerometer 206 or buttons 300, 302, 304, 306. Additionally, y-axis 616 and x-axis 618 may zoom in or zoom out to display any desired time span or energy range (e.g., a daily energy balance chart can be displayed).

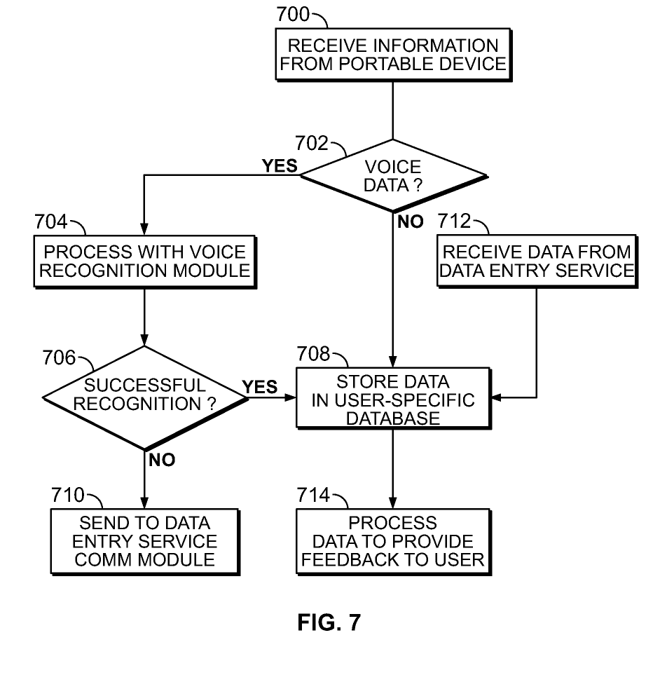

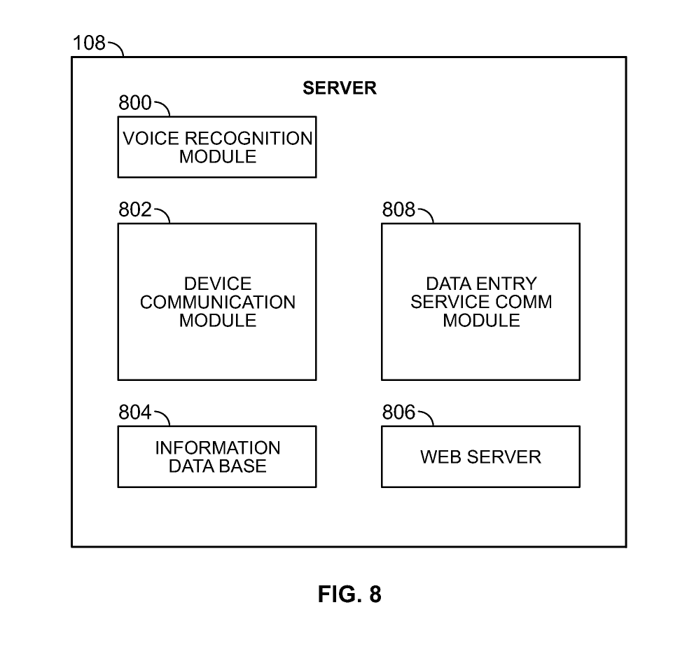

Referring now to FIG. 7, a method of operation of information management system 100 concerning weight management data as acquired by the portable journaling device 102. In general, information management system 100 and journaling device 102 is fully compliant with the Health Information Privacy Act of 1999. At module 700, server 108 receives data as acquired by journaling device 102 via communication network 106. In the example embodiment, server 108 includes a plurality of functional modules to facilitate the manipulation of data as acquired by journaling device 102. For example, as detailed in FIG. 8, server 108 includes a voice recognition module 800, a device communication module 802, information database 804, a web server module 806, and a data entry module 808, as described in further detail below. Communication network 106 is a multi-directional data communication path established between the computing system 104, the server 108, and data entry service 110. Communication network 106 can be any of a number of wireless or hardwired WAN, LAN, Internet, or other packet-based communication networks such that data can be shared among one or more journaling devices 102, computing systems 104, server 108, and data entry services 110. In general, the transmission of data between the server 108 and the computing system 104 may include communications data, media data, application data, or any other forms of data.

Process flow proceeds to module 702 where a determination is made at server 108 whether data acquired by journaling device 102 includes voice data. Upon an affirmative determination at module 702 process flow proceeds to module 704 where voice recognition module 800 transcribes the voice data and corresponding time stamp. Subsequently, at module 706, a determination is made to whether voice recognition was successful. Upon a successful evaluation at module 706 process flow proceeds to module 708 where the transcribed data is stored on server 108 in information database 804 in a predetermined electronic format. If voice recognition process is determined unsuccessful at module 706, data is sent to data entry service 110 at module 710 by data entry module 808 via communication network 106.

In the example embodiment, data entry service 110 receives data from server 108 and manually transcribes voice and corresponding timestamp data into a predetermined electronic format (e.g., a table). Subsequently, data entry service 110 transfers the transcribed data back to server 108, wherein data is received at module 712 and then transferred to module 708 for storage in information database 804 in a predetermined electronic format. In one aspect, the data as transcribed by the human interpreter would be fed back to a voice recognition software that would “learn” and store the subtleties of each user in the data base. The more the software learns about a person's particular voice pattern the less it requires human intervention for interpretation, in some embodiments.

In one example embodiment, the user would speak into a cell phone or PDA the food item or menu item they were about consume. An application on the cell phone or PDA would record the voice message and send the message, along with a time/date stamp, as an attachment via one of, for example, Email, SMS, and MMS to a web server. In the example embodiment, the web server would identify the user such as by caller ID or Email address and the received data would be added to the user data base. The data would be stored in the native voice format as well as would be sent to the voice recognition module (e.g., module 800 of FIG. 8,) where it would be converted into text. The text would be then compared against a data of, in the present example, food and/or menu items and corresponding nutritional information such as calories, fat grams, fiber grams, carbohydrate grams, glycemic indices, and others. The nutritional information would then be added to the users data base and cell phone or PDA. Once the nutritional information was on the users data base and cell phone or PDA the system software could extract this information for calculation and display of robust instantaneous energy balance information. Furthermore, the user could easily extract historical information to assess their decision and the impact of those decisions. Additionally, an automated software system could assess the users decision and automatically give them positive feedback and/or warning for good or poor food and activity choices.

At module 708 process flow proceeds to module 714 wherein data can be processed to provide feedback to the user. For example an email, voicemail, text message or phone call form a personal trainer can be utilized to provide encouragement for good choices and progress towards goals and suggestions for improvements. Data is sent to the portable device 102 via the communication network 106 and computing system 104 for presentation.

In certain embodiments, the computing system 104 is an intermediary between journaling device 102 and communication network 106, as depicted. In other embodiments journaling device 102 is equipped to communicate directly with the communication network 106. In one embodiment, computing system 104 is a standard computing device such as a personal computer (PC), or a laptop computer, or a cell phone, or a personal digital assistant (PDA). Computing system 104 can include a variety of input/output devices, a central processing unit (CPU), a data storage device, and a network device. Typical input/output devices include keyboards, mice, displays, microphones, speakers, disk drives, CD-ROM drives, and flash drives. Computer readable media, such as the data storage device, provide for data retention. By way of example, computer readable media can include computer storage media and communication media. Computer storage media includes volatile and non-volatile memory implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

Among the plurality of information stored on the data storage device is an operating system (OS) and applications. The client OS is a program that manages the hardware and software resources of the computing system 104. Respective applications utilize the resources of the computing system 104 to directly perform tasks specified by the user. For example, the computing system 104 may include one or more software applications, such as a journaling data processing program or an Internet browser.

In an alternative embodiment, data can be transferred via web server module 806 for display on a secure Internet website. A user logs into the website and the Web site then presents relevant information to the user, such as up-to-date weight management information and statistics. In certain embodiments, one or more plots of the information can be generated that allow the user to zoom in and out from a single event, out to days, weeks, months, etc, and include supplemental data analysis such as means, medians, averages, and standard deviations. In one embodiment, the website can have access to server 108 and data stored on information database 804. For example, detailed nutritional and activity information including all foods such as grocery foods, pre-prepared foods, restaurant foods can be stored on information database 804. Additionally, activities and calorie burn rates can be stored on information database 804 and accessed via website. In one embodiment, the website can provide access to a social networking group or database of anonymous users for mutual encourage of one another (e.g., MySpace or Facebook). In other embodiments, the website can provide email information regarding ideas of healthy food choices. In one embodiment, the website can have interactive features wherein weight loss concepts such as good fats, calorie density, glycemic index, BMR, pulse, blood pressure, and body mass index (BMI) are explained. Further, the website can provide access to a search engine that provides the user with access to recommended recipes and exercise routines.

The various embodiments described above are provided by way of illustration only and should not be construed as limiting. Various modifications and changes that may be made to the embodiments described above without departing from the true spirit and scope of the disclosure.

What is claimed is:

1. A portable journaling device comprising:
a processing unit;
at least one memory element having at least one software application comprising instructions executable by the processing unit stored thereon;
at least one communication device;
an input device configured to receive input from a user;
an output device configured to generate output to the user;
a communication device configured to send and receive digital data;
a processing unit; and
one or more memory elements storing instructions executable by the processing unit, wherein the instructions, when executed by the processing unit, cause the processing unit to perform a method comprising:
receiving a voice input from a user upon activation of the input device;
storing the voice input as voice data in the at least one memory element;
sending the voice data with the communication device to a remote server device;
receiving non-voice data from the remote server through the computer, the non-voice data relating to the voice data; and
generating an output to the user with the output device, the output relating to the non-voice data received from the remote server.

2. The journaling device of claim 1, wherein the at least one software application is selected from the group comprising: a journaling application; a browser application; a voice recognition application; and a messaging application.

3. The journaling device of claim 1, wherein the communication device is selected from the group comprising: a USB port; a wireless transceiver; and a Bluetooth device.

4. The journaling device of claim 1, wherein the input device is selected from the group comprising: a digital camera; one or more buttons; a microphone; and a touch display.

5. The journaling device of claim 1, wherein the output device is selected from the group comprising: a display; one or more light emitting diodes; a speaker; and a vibrator.

6. The journaling device of claim 1, further comprising an accelerometer configured to acquire information corresponding to an amount of activity of a user.

7. The journaling device of claim 1, wherein the journaling device is further configured to remotely access user specific files selected from the group comprising: a biometric information file; a food consumption file; an activities events file; an expense events file; a thought log file; a work log file; and a voice recognition correction file.

8. The journaling device of claim 1, wherein the input device is configured to acquire user specific information selected from the group comprising: weight management information; health information; intellectual information; budgeting information; financial management information; conversation information; and correspondence information.

9. The journaling device of claim 1, wherein the output device is configured to present user specific information selected from the group comprising: weight management information; health information; intellectual information; budgeting information; financial management information; conversation information; and correspondence information.

10. The journaling device of claim 9, wherein weight management and health information is selected from the group comprising: hydration; energy balance; basal metabolic rate; fiber; diet; activity suggestions; exercise routines; protein; fat; carbohydrates; sodium, and fiber intake, weight, body mass index, and pulse.

11. The journaling device of claim 10, wherein real time feedback is provided based on a status of the weight management and health information including feedback selected from the group comprising: a phone message; a text message; and an Email.

12. An information management system, comprising:
a portable journaling device configured to acquire, transfer, and present information, the journaling device comprising a processing unit, a memory device coupled to the processor and having at least one software application comprising instructions executable by the processing unit stored thereon, and an accelerometer coupled to the processor and configured to acquire information corresponding to an amount of activity of a user;
a server configured for at least receiving and storing information as acquired by the portable journaling device, the server comprising an information database and a voice recognition module, wherein the voice recognition module transcribes information as received from the portable journaling device; and
a data entry service configured to transcribe information as received from the server upon unsuccessful transcription by the voice recognition module and return the transcribed information to the server.

13. The information management system of claim 12, wherein the at least one software application is selected from the group comprising: a journaling application; a browser application; a voice recognition application; and a messaging application, and wherein information acquired by the journaling device is transferred to the server as an attachment to a message, and wherein a time stamp is one of: automatically associated with the acquired information by the journaling device and transferred as a message attachment with the acquired information; and associated with the acquired information by the server upon receiving said information.

14. The information management system of claim 12, wherein the information database is configured to store information selected from the group comprising: weight management information, health information, intellectual information, budgeting information, prayer information, financial management information, conversation information, and correspondence information.

15. The information management system of claim 12, wherein real time feedback is received at the journaling device based on a status of information as stored in the information database including information selected from the group comprising: a phone message; a text message; and an Email.

16. The information management system of claim 12, wherein the server automatically associates received information acquired by the journaling device with a specific user and then stores the received information in the information database.

17. A method for operating a health information management system, the method comprising:
receiving, at a server device via a communication network, voice data comprising weight management and health data from a portable journaling device;
attempting to convert the received voice data into a text format at the server device;
if attempting to convert is unsuccessful, automatically sending the voice data from the server device to a transcription service for manual transcription, and
upon successful transcription of the received voice data, storing the transcribed data in an information database at the server.

18. The method of claim 17, further comprising sending at least part of the transcribed data from the server to the portable journaling device.

19. The method of claim 17, further comprising associating a time stamp with the voice data as acquired by the portable journaling device, wherein the time stamp is one of: automatically associated with the acquired data by the journaling device and transferred as a message attachment with the acquired data; and associated with the acquired data by the server upon receiving said data.

20. The method of claim 17, further comprising receiving real time feedback at the journaling device based on a status of information as stored in the information database including feedback selected from the group comprising: a phone message; a text message; and Email.
